(19) United States
(12) Patent Application Publication
(10) Pub. No.: US 2012/0146381 A1
(43) Pub. Date: Jun. 14, 2012

(54) ARMREST WITH INTERCHANGEABLE ARM CAP

(75) Inventors: Douglas B. Spooner, Holland, MI (US); Paul J. Martus, Grand Rapids, MI (US); Keith A. McDowell, Belmont, MI (US)

(73) Assignee: AMERICAN SEATING COMPANY, Grand Rapids, MI (US)

(21) Appl. No.: 12/966,320

(22) Filed: Dec. 13, 2010

(51) Int. Cl. A47C 7/54; B23P 11/00

(52) U.S. Cl. 297/411.46; 297/411.2; 29/428

(57) ABSTRACT

An armrest for arena, stadium, classroom and auditorium seating. The armrest includes a base and an interchangeable arm cap secured to the base. The base defines a rectangular recess sized to telescopically receive a support leg, the recess including vertical crush ribs to retain the support leg within the recess. The arm cap is releasably joined with the base opposite the recess and is interchangeable with multiple different arm caps while the support leg remains inserted in the recess. The arm cap can include any desired finish, and can extend over the interface between the base and the arm cap to provide a clean appearance.

### BACKGROUND OF THE INVENTION

The present invention relates to armrests and more specifically to armrests for arena, stadium, classroom and auditorium seating.

Various armrests are available for seating assemblies in arenas, stadiums, classrooms, auditoriums and other seating applications. For example, known armrests can be secured to a seat, a seat back, or both, or can be floor or riser mounted. Known armrests are formed from a wide variety of materials with finishes suited to the particular application. For example, armrests intended for outdoor applications are often formed from molded plastic to withstand repeated exposure to weather, whereas armrests intended for indoor applications often include upholstery, plastic, gel pad, or finished wood to provide enhanced comfort and/or aesthetics.

Armrests in such venues are subject to repeated use and in many instances abuse, which can necessitate repair or replacement. Therefore, armrests often are designed for replacement. However, the replacement of armrests can be expensive because of the price of the materials involved.

### SUMMARY OF THE INVENTION

The aforementioned problems are overcome by the present invention, wherein an armrest includes a base and an interchangeable arm cap secured to the base.

In one embodiment, the armrest includes a base defining a rectangular recess to telescopically receive a support leg (vertical support member), such as a leg, standard or a stanchion. The recess includes vertical crush ribs on each of the recess sidewalls, the vertical crush ribs being adapted to deform when the support leg is received within the recess. An arm cap is releasably secured to the base opposite the recess and is interchangeable with different arm caps while the base remains secured to the support leg. The arm cap may include a wide variety of materials, such as plastic, wood, laminate, upholstery or gel padding.

In another embodiment, the present invention includes a method for assembling an armrest, including the steps of providing a base defining a rectangular recess, providing an arm cap including an outer surface and joining the arm cap contact surface to the base opposite the recess. The recess may include multiple vertical crush ribs adapted to deform when the support leg is telescopically received within the recess to reduce relative rotational and axial movement between the base and the support leg.

Accordingly, the present invention provides an improved armrest having enhanced versatility over a wide variety of applications while simultaneously reducing the material and labor costs associated with the installation and removal of the armrest. In addition, the armrest base provides improved stability and retention over known armrests, and the arm cap can be easily replaced without the need to remove the base portion from the corresponding support leg.

These and other features and advantages of the present invention will be more fully understood and appreciated in view of the description of the current embodiments, the drawings, and the appended claims.

### BRIEF DESCRIPTION OF THE DRAWINGS

FIG. 1 is a partially exploded perspective view of an armrest according to an embodiment of the present invention.

FIG. 2 is a top view of the armrest base;

FIG. 3 is a side view of the base;

FIG. 4 is a bottom view of the base;

FIG. 5 is a front view of the base;

FIG. 6 is a top view of the arm cap;

FIG. 7 is a side view of the arm cap;

FIG. 8 is a bottom view of the arm cap;

FIG. 9 is a front view of the arm cap of FIG. 6;

FIG. 10 is a side view of a support leg upon which the armrest may be mounted.

### DETAILED DESCRIPTION OF THE CURRENT EMBODIMENT

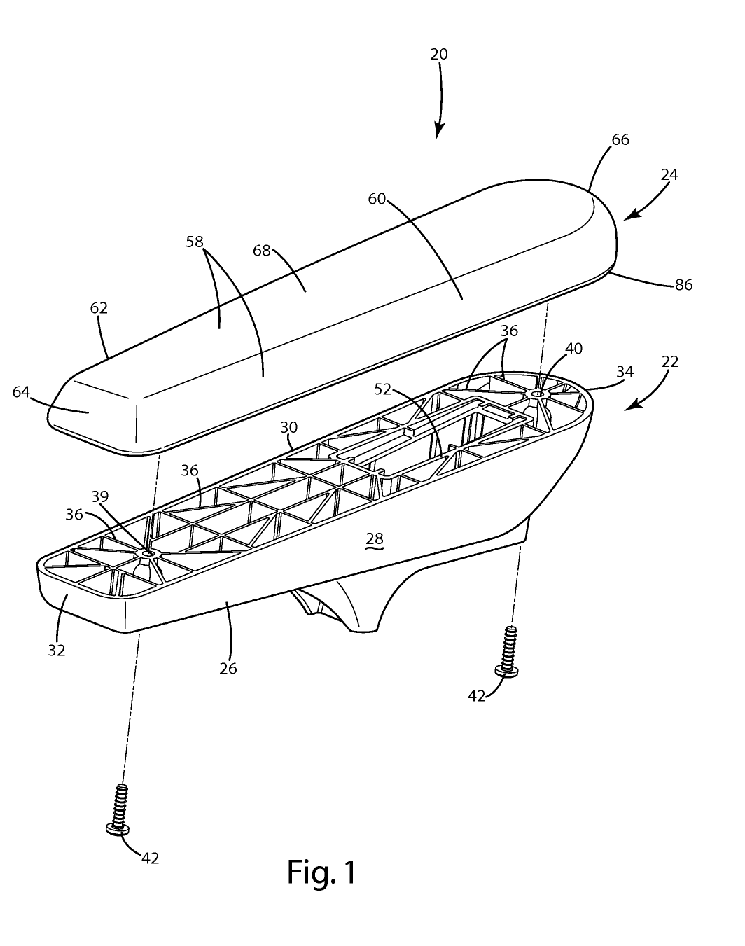

An armrest constructed in accordance with an embodiment of the present invention is illustrated in FIGS. 1-10 and generally designated 20. The armrest 20 includes a base 22 joined with an interchangeable arm cap 24 to provide a region of arm support for a user. The armrest 20 is supported by a support 90 leg secured to a corresponding seating assembly, the floor, or other support surface.

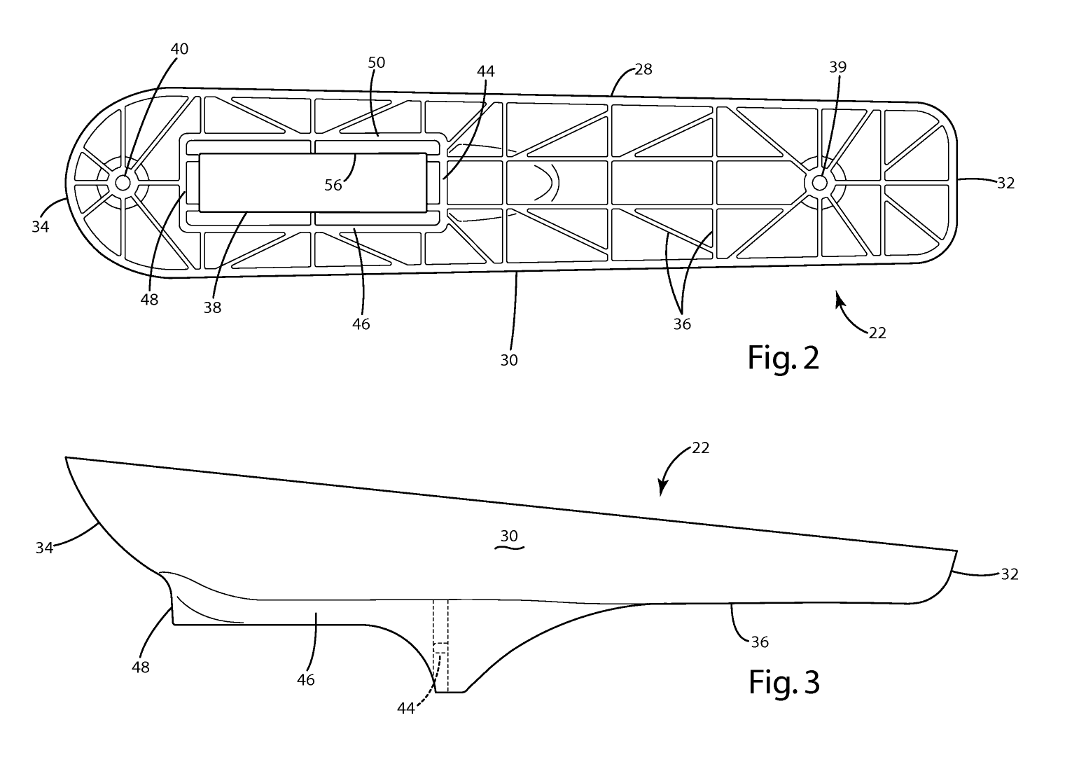

Referring to FIGS. 1-5, the base 22 is generally elongate and includes a convex outer surface 26 defining a generally U-shaped cross section for forming a bottom half of the armrest 20. The convex outer surface 26 includes first and second sidewalls 28, 30, first and second end walls 32, 34, and a generally planar lower surface 36 defining a slot or recess 38 for receiving a support leg. Perhaps as best shown in FIGS. 1-2, the base 22 includes multiple longitudinal, diagonal, and transverse reinforcing webs 36 for strengthening the base 22 against torsional loads and bending moments. The reinforcing webs 36 include first and second bosses 39, 40 for receiving screws 42 or other suitable fasteners to secure the base 22 to the arm cap 24.

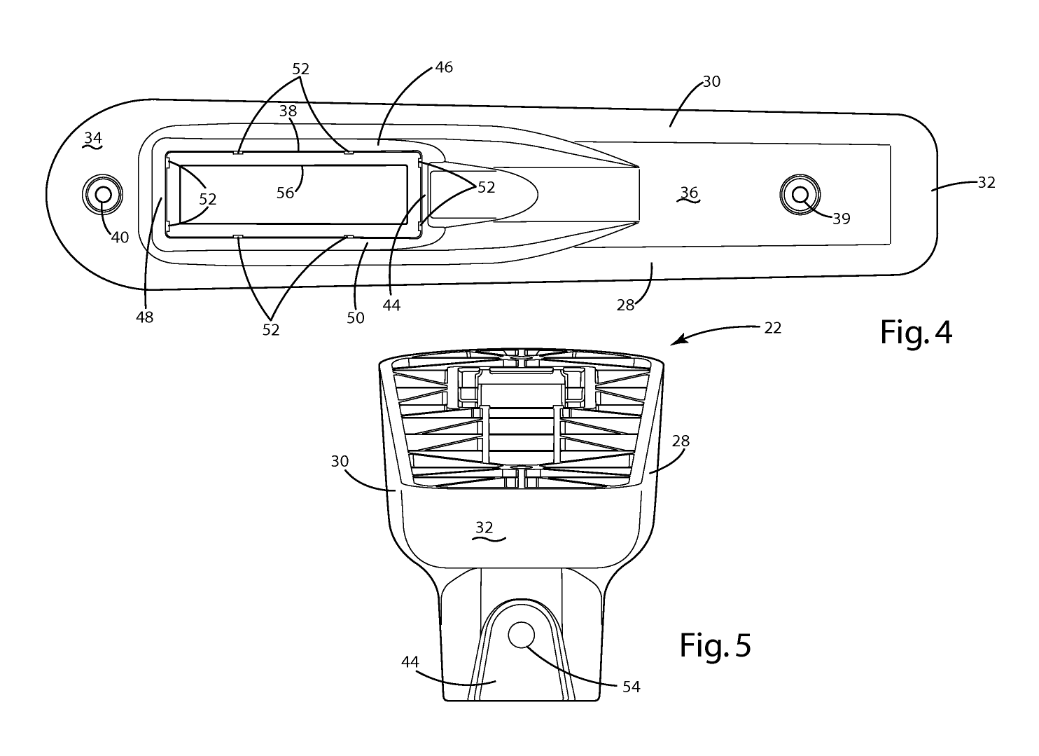

Referring now to FIGS. 2 and 4, the base recess 38 is generally rectangular and includes four sidewalls 44, 46, 48, 50, each including at least one vertical crush rib 52 adapted to deform when the support leg 90 is telescopically received within the recess 38. As shown, the vertical crush ribs 52, but may be any suitable shape as desired to frictionally engage the support leg 90 when inserted into the recess 38. In addition, and perhaps as best shown in FIG. 2, the recess 38 defines a width approximately equal to or less than one half of the corresponding width of the outer surface 26. At least one of the recess sidewalls (as shown, the forward sidewall 44) defines a fastener hole 54 for alignment with a corresponding fastener boss in the support leg 90. Accordingly, the recess sidewalls 44, 46, 48, 50, the vertical crush ribs 52 and the fastener hole 54 cooperate to secure the base 22 to the support leg 90 and to reduce relative rotational and axial movement between the base 22 and the support leg 90. In addition, the recess 38 defines an optional opening 56 in the bottom portion thereof to permit visual inspection of the support leg 90 during installation or removal of the base 22.

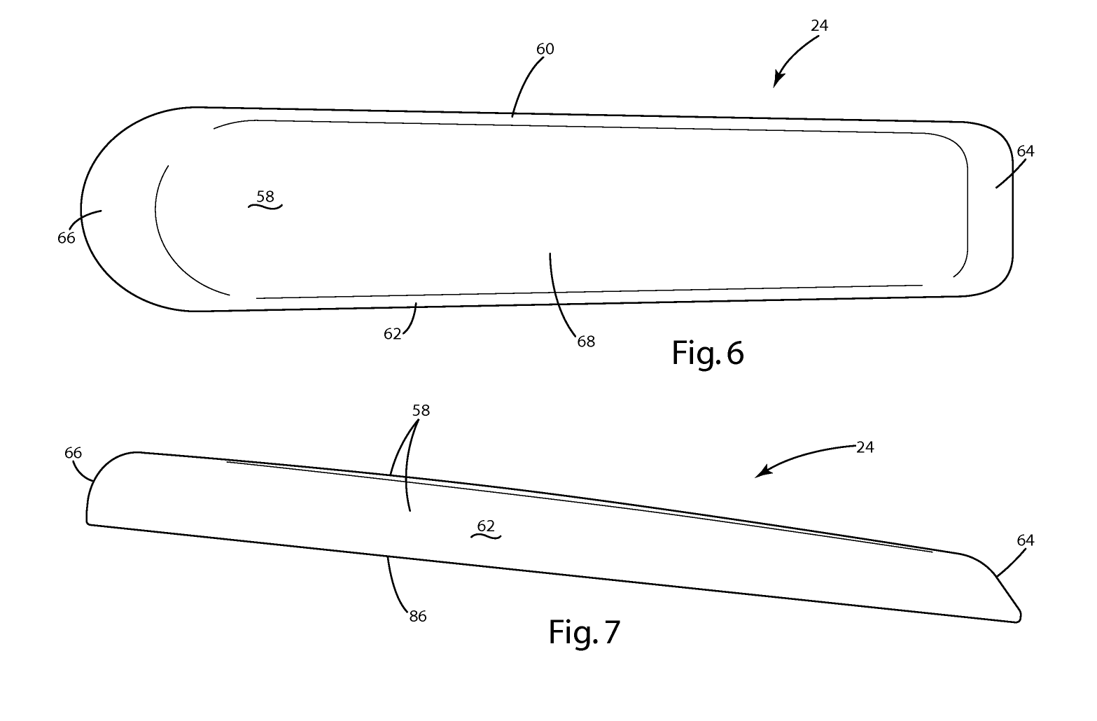

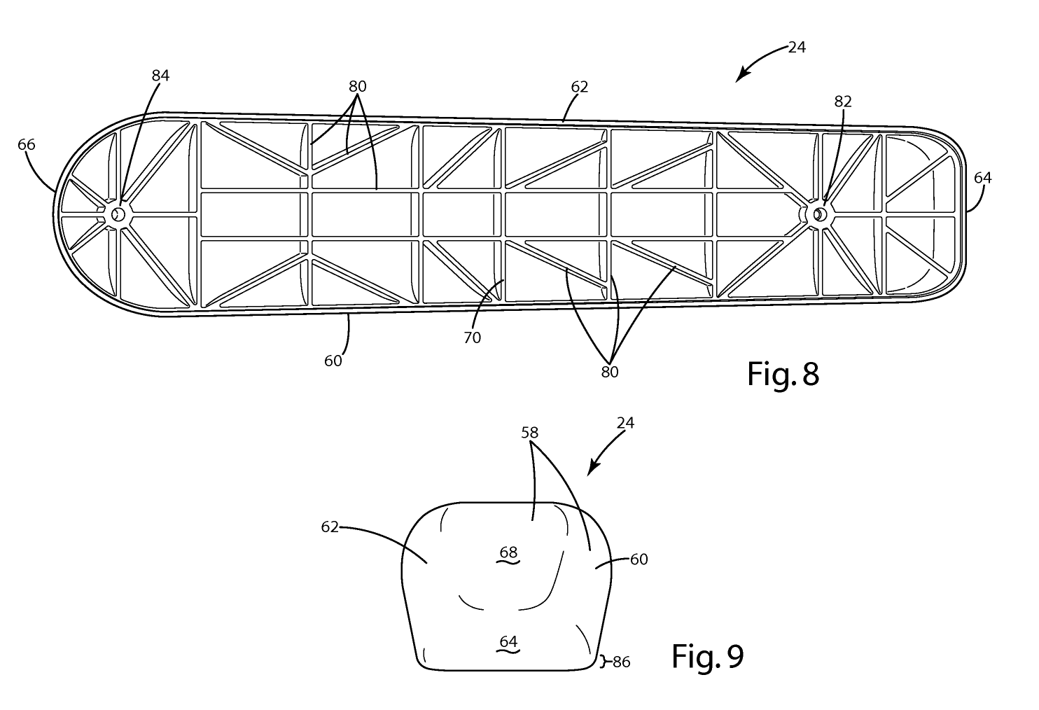

Referring to FIGS. 6-9, the armrest 20 includes a generally elongate arm cap 24 that is sized to form an upper portion of the armrest 20. The arm cap 24 includes a generally convex outer shell-like surface 58 defining an inverted U-shaped cross section. The outer surface 58 includes first and second sidewalls 60, 62, first and second end walls 64, 66, and a generally planar upper surface 68. As shown in FIG. 8, the arm cap 24 includes a contact surface 70 opposite the outer surface 58, the contact surface 70 including multiple longitudinal, diagonal, and transverse reinforcing webs 80 to strengthen the arm cap 24 against torsional loads and bending moments. Mounted to the support webs 80 are two mounting bosses 82, 84 for receiving screws 42 or other suitable fasteners to secure the arm cap 24 to the base 22 as shown in FIG. 1.

The first and second sidewalls 60, 62 and first and second end walls 64, 66 include a downward extending lip 86 about the periphery of the outer surface 58. When the arm cap 24 is joined with the base 22 to define an interface therebetween, the arm cap lip 86 extends over the interface to provide a clean appearance. In this respect, the arm cap 24 defines a recess opposite the outer surface 58 for receiving the armrest base 22. In addition, a bonding resin or other suitable adhesive optionally can be applied to the interior of the lip 86 to secure the arm cap 24 to the base 22 about their respective peripheries.

The base 22 and arm cap 24 can each be relative thin-walled and formed of a rigid molded polymeric material or other material as desired. Though not shown, the arm cap 24 can include a desired material finish, including, for example, a wood finish, a laminate finish, upholstered padding, or gel padding. Alternatively, the arm cap 24 can be formed entirely of the desired finishing material, including wood for example, according to the desired application. The arm caps can be fabricated from any suitable material and colored or textured as desired, thus extending their versatility over conventional armrests.

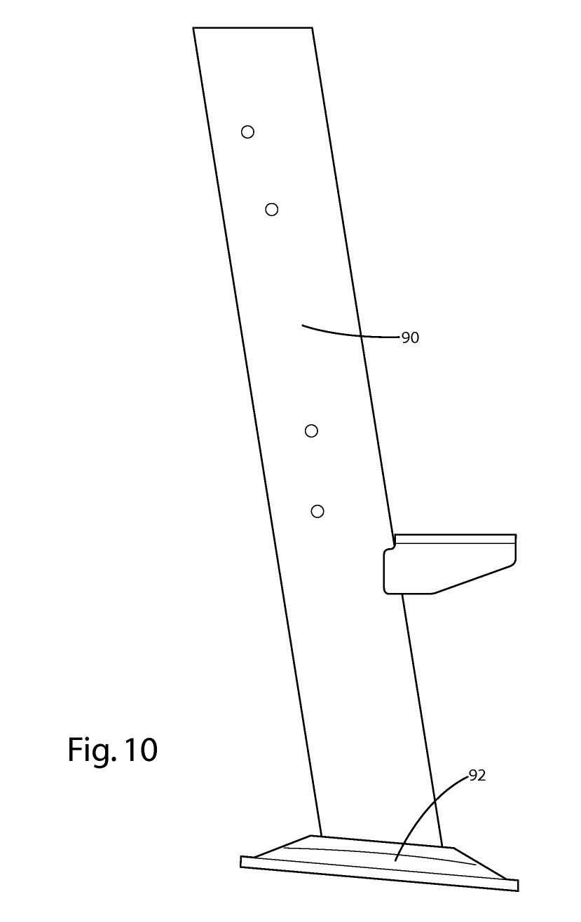

An improved method for installing an armrest 20 according to the present invention can include providing a base 22 for an armrest 20, the base defining a recess for receiving a support leg 90, securing the base 22 to the support leg 90, the support leg 90 being telescopically received within the recess, providing an arm cap 24 including an outer surface, and fitting the arm cap to the base. The armrest 20 can be secured to the floor or other surface via a support leg 90 as shown in FIG. 10. The support leg 90 can likewise be secured to a sloped floor or other surface via a floor plate 92 in accordance with convention methods, while in other embodiments the armrest 20 can be secured directly to the seat assembly (not shown) itself. Alternatively, the support leg 90 can be adapted or designed for mounting on a generally vertical surface such as a riser mount or a step face. In addition, the recess can include four sidewalls each having at least one vertical crush rib 52 disposed thereon, the recess being proportioned to tightly correspond to the exterior of the support leg 90. In this respect, the support leg 90 can be telescopically received within the recess to reduce rotational and axial movement between the support leg 90 and the base 22.

Substituting one arm cap 24 for another arm cap 24 may be repeated as often as necessary. As such, the useful life and versatility of each armrest 20 is greatly extended. According to the method of the present invention, each interchangeable arm cap 24 may be installed or removed from a corresponding base 22 while the base 22 is securely fastened to the support leg 90. For example, the base 22 can define first and second fastener holes 39, 40 for alignment with corresponding first and second screw bosses 82, 84 in the arm cap 24, wherein the first and second fastener holes 39, 40 are disposed outside of the recess to permit the installation (and removal) of the arm cap while the support leg 90 remains securely within the recess. By virtue of the present invention, the armrest 20 can be easily adapted to changing decors in a theatre or performance hall, and is readily suited for replacement in high traffic environments such as in academic auditoriums and sports arena or stadium. In addition, the combination of a rectangular recess or recess, vertical crush ribs 52, and at least one horizontal fastener cooperate to secure the base 22 to the support leg 90 while minimizing axial or rotational movement of the base from its desired position.

The above description is that of current embodiment of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. An armrest comprising:
a base defining a rectangular recess adapted to telescopically receive a support leg, the recess including a plurality of vertical crush ribs adapted to engage the support leg when received within the recess; and
an arm cap removably secured to the base.

2. The armrest of claim 1 wherein the arm cap is interchangeable with a plurality of visually distinctive arm caps and removable from the base while the support leg remains received within the recess.

3. The armrest of claim 1 wherein the arm cap includes an outer surface including one of a plastic, a wood finish, a laminate finish, upholstered padding or gel padding.

4. The armrest of claim 1 wherein the recess includes a plurality of sidewalls, at least one of the plurality of vertical crush ribs being disposed on each of the plurality of sidewalls.

5. The armrest of claim 4 wherein the plurality of vertical crush ribs are adapted to deform when the support leg is telescopically received within the recess.

6. The armrest of claim 4 wherein one of the plurality of sidewalls defines a fastener hole for alignment with a corresponding fastener hole in the support leg.

7. The armrest of claim 1 wherein the recess defines a width approximately equal to or less than one half of the corresponding width of the arm cap.

8. The armrest of claim 1 wherein:
the arm cap includes an inner surface defining first and second fastener holes; and
the base defines third and fourth fastener holes for alignment with the corresponding first and second fastener holes in the arm cap, wherein the third and fourth fastener holes are disposed outside of the recess to permit removal of the arm cap from the base while the support leg remains received within the recess.

9. An armrest for attachment to a support leg, comprising:
an arm cap including an outer surface; and
a base releasably supporting the arm cap, the base defining a rectangular recess adapted to telescopically receive the support leg and including a plurality of vertical crush ribs to frictionally engage the support leg when received within the recess.

10. The armrest of claim 9 wherein the recess includes a plurality of sidewalls, at least one of the plurality of vertical crush ribs being disposed on each of the plurality of sidewalls.

11. The armrest of claim 9 wherein the plurality of vertical crush ribs are adapted to deform when the support leg is telescopically received within the recess.

12. The armrest of claim 9 wherein the recess defines a width approximately equal to or less than one half of the corresponding width of the arm cap.

13. The armrest of claim 9 wherein:
the arm cap includes a contact surface defining first and second fastener holes; and
the base defines third and fourth fastener holes for alignment with the corresponding first and second fastener holes in the arm cap contact surface, wherein the third and fourth fastener holes are disposed outside of the recess to permit removal of the arm cap from the base while the support leg remains received within the recess.

14. The armrest of claim 9 wherein the base comprises plastic.

15. The armrest of claim 9 wherein the arm cap outer surface includes one of a plastic, a wood finish, a laminate finish, upholstered padding or gel padding.

16. A method of assembling an armrest, comprising:
providing a base defining a rectangular recess having four sidewalls and at least one vertical crush rib on selected ones of the four sidewalls;
providing an arm cap including an outer surface; and
securing the arm cap to the base.

17. The method according to claim 16 further including securing the base to a support leg, the support leg being telescopically received within the recess to reduce relative rotational and axial movement between the base and the support leg.

18. The method according to claim 17 wherein the arm cap is interchangeable with a plurality of visually distinctive arm caps and removable from the base while the support leg remains received within the recess.

19. The method according to claim 16 wherein the plurality of vertical crush ribs are adapted to deform when a support leg is telescopically received within the recess.

20. The method according to claim 16 wherein the recess defines a width approximately equal to or less than one half of the corresponding width of the arm cap.

21. The method according to claim 16 wherein:
the arm cap includes a contact surface having a plurality of reinforcing webs; and
the arm cap outer surface includes one of wood, laminate, upholstered padding or gel padding.

22. The method according to claim 21 wherein:
the arm cap contact surface defines first and second fastener holes; and
the base includes third and fourth fastener holes for alignment with the corresponding first and second fastener holes in the arm cap, wherein the third and fourth fastener holes are disposed outside of the recess to permit removal of the arm cap from the base while the base remains secured to a support leg.
